(19) United States
(12) Patent Application Publication
(10) Pub. No.: US 2024/0167255 A1
(43) Pub. Date: May 23, 2024

(54) Overhead Showerhead Installation Kit Assembly And Method Of Use

(71) Applicant: James Greenizer, Arlington, WA (US)

(72) Inventor: James Greenizer, Arlington, WA (US)

(21) Appl. No.: 17/992,669

(22) Filed: Nov. 22, 2022

(51) Int. Cl. E03C 1/04

(52) U.S. Cl. CPC E03C 1/0408; E03C 2001/026

(57) ABSTRACT

An overhead showerhead installation kit assembly for adding an overhead showerhead to a shower enclosure includes a two-way valve, which is insertable between an inlet pipe of the shower enclosure and a standard showerhead. A pair of couplers is attached singly to opposed ends of an arcuate pipe, with the couplers being used to attach the arcuate pipe to end walls of a shower enclosure, with the arcuate pipe being positioned above the inlet pipe and curving toward a ceiling of the shower enclosure. A secondary showerhead is attached to the arcuate pipe and is connected to the two-way valve by a flexible conduit that extends through the arcuate pipe. A handle attached to the two-way valve is used manipulate the two-way valve to selectively direct water from the inlet pipe to at least one of the standard showerhead and the secondary showerhead.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to showerhead installation kits and more particularly pertains to a new showerhead installation kit for adding an overhead showerhead to a shower enclosure. The present invention discloses a showerhead installation kit that can be used to easily add an overhead showerhead to an existing installation.

### (2) Description of Related Art Including Information Disclosed Under 37 CFR 1.97 and 1.98

The prior art relates to showerhead installation kits, which may comprise kits for installing opposing showerheads or one or more overhead showerheads, wherein the structural means for supporting the added showerheads also carries water to the added showerheads. Related prior art includes kits comprising flexible tubes for adding secondary showerheads to ceiling of shower enclosures and shower assemblies comprising standpipes to which an overhead showerhead and a handheld spray head are connected. What is lacking in the prior art is a showerhead installation kit comprising an arcuate pipe, which act as the structural support for an overhead showerhead, wherein water is supplied to the overhead showerhead by a flexible conduit that extends from a two-way valve connected to the inlet pipe of the shower enclosure through the arcuate pipe, thereby allowing installation without requiring professional plumbing skills.

### BRIEF SUMMARY OF THE INVENTION

An embodiment of the disclosure meets the needs presented above by generally comprising a two-way valve, which is configured to be insertable between an inlet pipe and a standard showerhead so that the inlet pipe and the standard showerhead are connected to an inlet port and a first outlet port of the two-way valve, respectively. The standard showerhead is in selective fluidic communication with the inlet pipe. Each coupler of a pair of couplers is attached to a respective opposed end of an arcuate pipe. The coupler is configured to attach to a respective end wall of a shower enclosure so that the arcuate pipe is positioned above the inlet pipe and curves from its opposed ends toward a ceiling of the shower enclosure.

A secondary showerhead is attached to the arcuate pipe between its opposed ends. A flexible conduit is attached to and extends from a second outlet port of the two-way valve through a hole in the arcuate pipe to the secondary showerhead. The secondary showerhead is in selective fluidic communication with the inlet pipe. A handle is operationally attached to the two-way valve and is configured to be grasped in a hand of a user. The user can manipulate the two-way valve using the handle to selectively direct water from the inlet pipe to at least one of the standard showerhead and the secondary showerhead.

Another embodiment of the disclosure includes an overhead showerhead installation kit system, which comprises a shower enclosure in which an overhead showerhead installation kit assembly, as described above, is installed.

Yet another embodiment of the disclosure includes a method of installing a secondary showerhead in a shower enclosure, which starts with providing an overhead showerhead installation kit assembly, as described in the disclosure above. Subsequent steps of the method are installing the couplers and attaching the arcuate pipe to the couplers. Additional steps are turning off the water supply to the inlet pipe of the shower enclosure, removing the standard showerhead, attaching the two-way valve to the inlet pipe, attaching the standard showerhead to the two-way valve, attaching the flexible conduit to the two-way valve, and turning on the water supply to the inlet pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an overhead showerhead installation kit assembly according to an embodiment of the disclosure.

FIG. 2 is a cross-sectional view of an embodiment of the disclosure.

FIG. 3 is a bottom isometric perspective view of an embodiment of the disclosure.

FIG. 4 is an end view of an embodiment of the disclosure.

FIG. 5 is an in-use view of an embodiment of the disclosure.

FIG. 6 is a cross-sectional view of an embodiment of the disclosure.

FIG. 7 is a cross-sectional view of an embodiment of the disclosure.

FIG. 8 is a flow diagram for a method utilizing an embodiment of the disclosure.

### DETAILED DESCRIPTION OF THE INVENTION

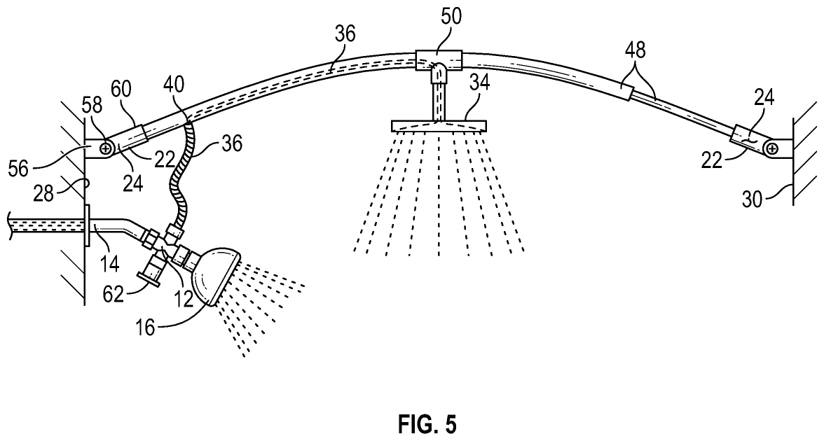

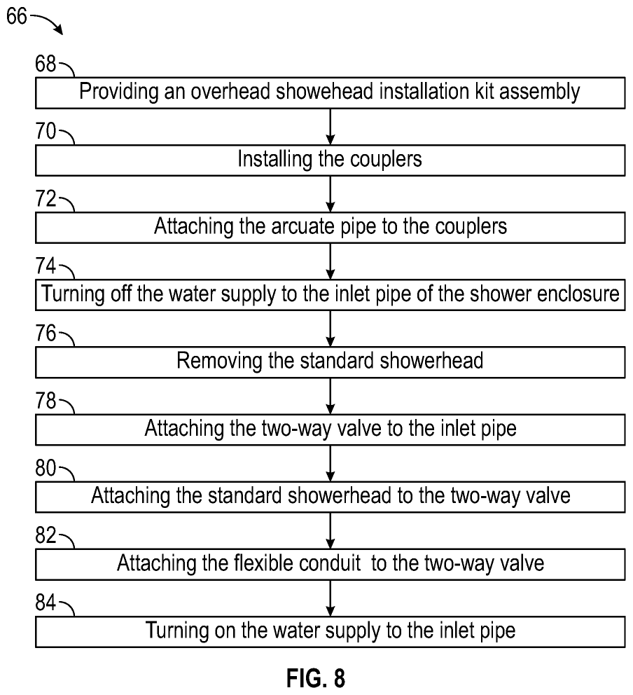

With reference now to the drawings, and in particular to FIGS. 1 through 8 thereof, a new showerhead installation kit embodying the principles and concepts of an embodiment of the disclosure and generally designated by the reference numeral 10 will be described.

As best illustrated in FIGS. 1 through 8, the overhead showerhead installation kit assembly 10 generally comprises a two-way valve 12, which is configured to be insertable between an inlet pipe 14 and a standard showerhead 16 so that the inlet pipe 14 and the standard showerhead 16 are connected to an inlet port 18 and a first outlet port 20 of the two-way valve 12, respectively. The standard showerhead 16 is in selective fluidic communication with the inlet pipe 14.

Each coupler 22 of a pair of couplers 22 is attached to a respective opposed end 24 of an arcuate pipe 26. The coupler 22 is configured to attach to a respective end wall 28 of a shower enclosure 30 so that the arcuate pipe 26 is positioned above the inlet pipe 14 and curves from its opposed ends 24 toward a ceiling 32 of the shower enclosure 30.

A secondary showerhead 34 is attached to the arcuate pipe 26 between its opposed ends 24. A flexible conduit 36 is attached to and extends from a second outlet port 38 of the two-way valve 12 through a hole 40 in the arcuate pipe 26 to the secondary showerhead 34. The secondary showerhead 34 is in selective fluidic communication with the inlet pipe 14.

A handle 42 is operationally attached to the two-way valve 12 and is configured to be grasped in a hand of a user. The user can manipulate the two-way valve 12, using the handle 42, to selectively direct water from the inlet pipe 14 to at least one of the standard showerhead 16 and the secondary showerhead 34.

The overhead showerhead installation kit assembly 10 is anticipated to be useful to users who would like to easily modify an existing shower enclosure 30 to include a secondary showerhead 34 that sprays directly down upon a user. Such a configuration may be of particular benefit for handicap accessible shower enclosures 30. The overhead showerhead installation kit assembly 10 is very easy to install and does not require professional installation. Rather, a layman can install the overhead showerhead installation kit assembly 10 using only a wrench, drill, and screwdriver to achieve a functional installation with a professional appearance.

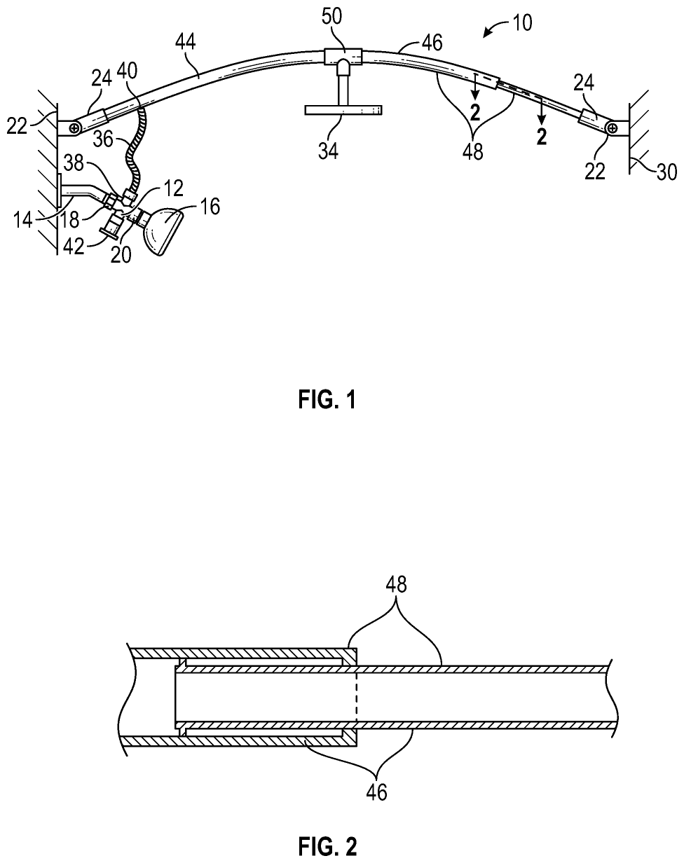

As shown in FIGS. 1 and 2, the arcuate pipe 26 comprises a first segment 44, in which the hole 40 is positioned, and a second segment 46, which comprises a pair of nested sections 48 so that the second segment 46 is selectively extensible. The second segment 46 being selectively extensible allows the arcuate pipe 26 to be sized to shower enclosures 30 with end walls 28 that are separated by a variety of distances. A three-way connector 50 is attached to the first segment 44, the second segment 46, and the secondary showerhead 34. Connection of the first segment 44, the second segment 46, and the secondary showerhead 34 to the three-way connector 50 can be achieved by a variety of methods known to those skilled in the art of pipe connections, such as, but not limited to, quick fittings, sweating, and threading.

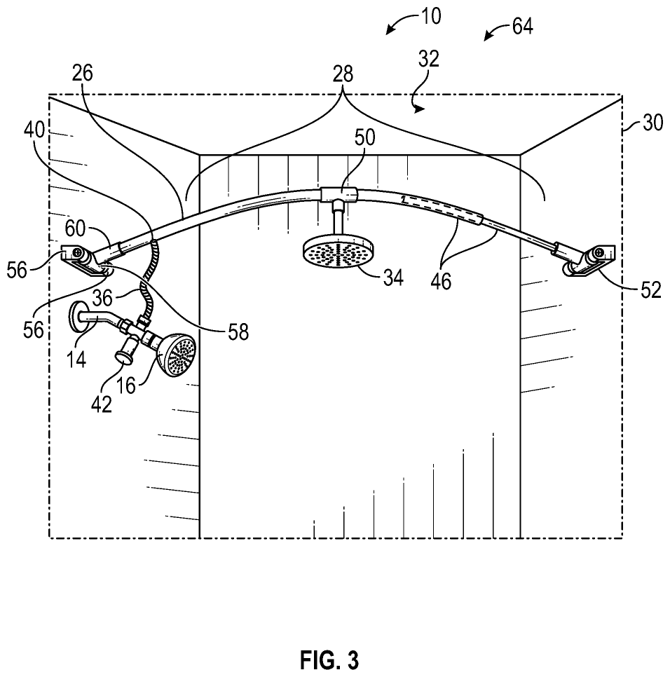

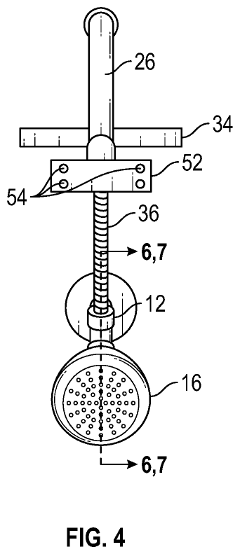

As shown in FIGS. 3 and 4, each coupler 22 comprises a plate 52, which is configured to be attached to the respective end wall 28, such as by means of mounting orifices 54 positioned in the plate 52 and mounting hardware (not shown), such as screws. A pair of arms 56 is attached to and extends from the plate 52 so that the pair of arms 56 is substantially horizontal. An axle 58 is rotationally attached to and extends between the arms 56. A tube 60 is attached to and extends from the axle 58. The tube 60 is circumferentially complementary to the arcuate pipe 26 so that a respective opposed end 24 of the arcuate pipe 26 is selectively insertable into the tube 60 to mount the arcuate pipe 26 between the end walls 28 of the shower enclosure 30. The tube 60 being rotatable about the axle 58 facilitates positioning of the arcuate pipe 26 in shower enclosures 30 with end walls 28 separated by a variety of distances.

The present invention anticipates the coupler 22 being of other configurations and comprising other coupling means, such as, but not limited to, adhesives, tile integrated fasteners, tension rods, and the like.

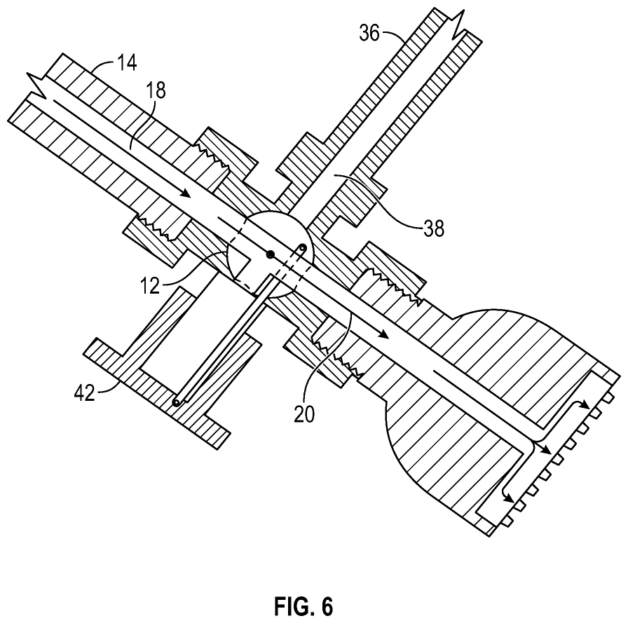

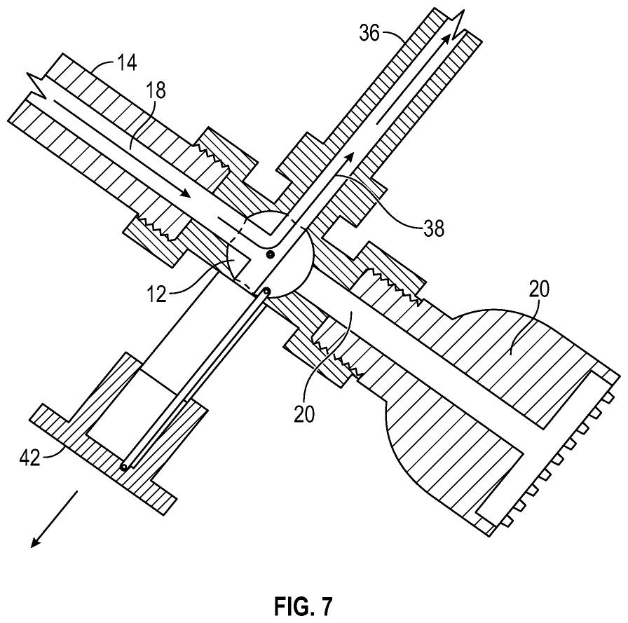

As shown in FIGS. 6 and 7, the handle 42 may comprise a pull knob 62, which is configured to be grasped in the hand of the user. The user can selectively pull on the pull knob 62 to move the two-way valve 12 between a first position, as shown in FIG. 6, wherein the inlet pipe 14 is in fluidic communication with the first outlet port 20, and a second position, as shown in FIG. 7, wherein the inlet pipe 14 is in fluidic communication with the second outlet port 38. The user would simply push on the pull knob 62 to return two-way valve 12 from the second position to the first position.

The present invention also anticipates the handle 42 being rotatable for moving the two-way valve 12 between the first position, the second position, a third position, wherein the inlet pipe 14 is in fluidic communication with both the first outlet port 20 and the second outlet port 38, and a fourth position, wherein the inlet port 18 is closed.

The present invention also anticipates an overhead showerhead installation kit system 64, which comprises a shower enclosure 30 in which the overhead showerhead installation kit assembly 10, as described above, is installed.

In use, the overhead showerhead installation kit assembly 10 enables a method of installing a secondary showerhead in a shower enclosure 66. The method 66 comprises a provision step 68, which entails providing an overhead showerhead installation kit assembly 10. A first installation step 70 of the method 66 is installing the couplers 22. A second installation step 72 of the method 66 is attaching the arcuate pipe 26 to the couplers 22. A first plumbing step 74 of the method 66 is turning off the water supply to the inlet pipe 14 of the shower enclosure 30. A second plumbing step 76 of the method 66 is removing the standard showerhead 16. A third plumbing step 78 of the method 66 is attaching the two-way valve 12 to the inlet pipe 14. A fourth plumbing step 80 and a fifth plumbing step 82 of the method 66 are attaching the standard showerhead 16 and the flexible conduit 36 to the two-way valve 12. A sixth plumbing step 84 of the method 66 is turning on the water supply to the inlet pipe 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An overhead showerhead installation kit assembly comprising:
a two-way valve configured to be insertable between an inlet pipe and a standard showerhead, such that the inlet pipe and the standard showerhead are connected to an inlet port and a first outlet port of the two-way valve, respectively, and such that the standard showerhead is in selective fluidic communication with the inlet pipe;
an arcuate pipe;
a pair of couplers, each coupler being attached to a respective opposed end of the arcuate pipe and being configured for attaching to a respective end wall of a shower enclosure, such that the arcuate pipe is positioned above the inlet pipe and curves from its opposed ends toward a ceiling of the shower enclosure;
a secondary showerhead attached to the arcuate pipe between its opposed ends;
a flexible conduit attached to and extending from a second outlet port of the two-way valve through a hole in the arcuate pipe to the secondary showerhead, such that the secondary showerhead is in selective fluidic communication with the inlet pipe; and
a handle operationally attached to the two-way valve, wherein the handle is configured for grasping in a hand of a user for manipulating the two-way valve for selectively directing water from the inlet pipe to at least one of the standard showerhead and the secondary showerhead.

2. The overhead showerhead installation kit assembly of claim 1, wherein the arcuate pipe comprises:
a first segment in which the hole is positioned;
a second segment comprising a pair of nested sections, such that the second segment is selectively extensible; and
a three-way connector attached to the first segment, the second segment, and the secondary showerhead.

3. The overhead showerhead installation kit assembly of claim 1, wherein each coupler comprises:
a plate configured for attaching to the respective end wall;
a pair of arms attached to and extending from the plate, such that the pair of arms is substantially horizontal;
an axle rotationally attached to and extending between the arms; and
a tube attached to and extending from the axle, the tube being circumferentially complementary to the arcuate pipe, such that a respective opposed end of the arcuate pipe is selectively insertable into the tube for mounting the arcuate pipe between the end walls of the shower enclosure.

4. The overhead showerhead installation kit assembly of claim 1, wherein the handle comprises a pull knob configured for grasping in the hand of the user, positioning the user for selectively pulling on the pull knob for moving the two-way valve between a first position, wherein the inlet pipe is in fluidic communication with the first outlet port, and a second position, wherein the inlet pipe is in fluidic communication with the second outlet port.

5. The overhead showerhead installation kit assembly of claim 1, further including:
the arcuate pipe comprising:
a first segment in which the hole is positioned,
a second segment comprising a pair of nested sections, such that the second segment is selectively extensible, and
a three-way connector attached to the first segment, the second segment, and the secondary showerhead;
each coupler comprising:
a plate configured for attaching to the respective end wall,
a pair of arms attached to and extending from the plate, such that the pair of arms is substantially horizontal,
an axle rotationally attached to and extending between the arms, and
a tube attached to and extending from the axle, the tube being circumferentially complementary to the arcuate pipe, such that a respective opposed end of the arcuate pipe is selectively insertable into the tube for mounting the arcuate pipe between the end walls of the shower enclosure; and
the handle comprising a pull knob configured for grasping in the hand of the user, positioning the user for selectively pulling on the pull knob for moving the two-way valve between a first position, wherein the inlet pipe is in fluidic communication with the first outlet port, and a second position, wherein the inlet pipe is in fluidic communication with the second outlet port.

6. An overhead showerhead installation kit system comprising:
a shower enclosure having an inlet pipe;
a two-way valve connected to and positioned between the inlet pipe and a standard showerhead, such that the inlet pipe and the standard showerhead are connected to an inlet port and a first outlet port of the two-way valve, respectively, and such that the standard showerhead is in selective fluidic communication with the inlet pipe;
a pair of couplers, each coupler being attached to a respective end wall of a shower enclosure;
an arcuate pipe attached to and extending between the couplers, such that the arcuate pipe is positioned above the inlet pipe and curves from its opposed ends toward a ceiling of the shower enclosure;
a secondary showerhead attached to the arcuate pipe between its opposed ends;
a flexible conduit attached to and extending from a second outlet port of the two-way valve through a hole in the arcuate pipe to the secondary showerhead, such that the secondary showerhead is in selective fluidic communication with the inlet pipe; and
a handle operationally attached to the two-way valve, wherein the handle is configured for grasping in a hand of a user for manipulating the two-way valve for selectively directing water from the inlet pipe to at least one of the standard showerhead and the secondary showerhead.

7. The overhead showerhead installation kit system of claim 6, wherein the arcuate pipe comprises:
a first segment in which the hole is positioned;
a second segment comprising a pair of nested sections, such that the second segment is selectively extensible; and
a three-way connector attached to the first segment, the second segment, and the secondary showerhead.

8. The overhead showerhead installation kit system of claim 6, wherein each coupler comprises:
a plate attached to the respective end wall;
a pair of arms attached to and extending from the plate, such that the pair of arms is substantially horizontal;
an axle rotationally attached to and extending between the arms; and
a tube attached to and extending from the axle, the tube being circumferentially complementary to the arcuate pipe, a respective opposed end of the arcuate pipe being inserted into the tube, such that the arcuate pipe is mount the between the end walls of the shower enclosure.

9. The overhead showerhead installation kit system of claim 6, wherein the handle comprises a pull knob configured for grasping in the hand of the user, positioning the user for selectively pulling on the pull knob for moving the two-way valve between a first position, wherein the inlet pipe is in fluidic communication with the first outlet port, and a second position, wherein the inlet pipe is in fluidic communication with the second outlet port.

10. The overhead showerhead installation kit system of claim 6, further including:
the arcuate pipe comprising:
a first segment in which the hole is positioned,
a second segment comprising a pair of nested sections, such that the second segment is selectively extensible, and
a three-way connector attached to the first segment, the second segment, and the secondary showerhead;
each coupler comprising:
a plate attached to the respective end wall,
a pair of arms attached to and extending from the plate, such that the pair of arms is substantially horizontal,
an axle rotationally attached to and extending between the arms, and
a tube attached to and extending from the axle, the tube being circumferentially complementary to the arcuate pipe, a respective opposed end of the arcuate pipe being inserted into the tube, such that the arcuate pipe is mount the between the end walls of the shower enclosure; and
the handle comprising a pull knob configured for grasping in the hand of the user, positioning the user for selectively pulling on the pull knob for moving the two-way valve between a first position, wherein the inlet pipe is in fluidic communication with the first outlet port, and a second position, wherein the inlet pipe is in fluidic communication with the second outlet port.

11. A method of installing a secondary showerhead in a shower enclosure comprising the steps of:
providing an overhead showerhead installation kit assembly comprising:
a two-way valve configured to be insertable between an inlet pipe and a standard showerhead, such that the inlet pipe and the standard showerhead are connected to an inlet port and a first outlet port of the two-way valve, respectively, and such that the standard showerhead is in selective fluidic communication with the inlet pipe,
an arcuate pipe,
a pair of couplers, each coupler being attached to a respective opposed end of the arcuate pipe and being configured for attaching to a respective end wall of a shower enclosure, such that the arcuate pipe is positioned above the inlet pipe and curves from its opposed ends toward a ceiling of the shower enclosure,
a secondary showerhead attached to the arcuate pipe between its opposed ends,
a flexible conduit attached to and extending from a second outlet port of the two-way valve through a hole in the arcuate pipe to the secondary showerhead, such that the secondary showerhead is in selective fluidic communication with the inlet pipe, and
a handle operationally attached to the two-way valve, wherein the handle is configured for grasping in a hand of a user for manipulating the two-way valve for selectively directing water from the inlet pipe to at least one of the standard showerhead and the secondary showerhead;
installing the couplers;
attaching the arcuate pipe to the couplers;
turning off the water supply to the inlet pipe of the shower enclosure;
removing the standard showerhead;
attaching the two-way valve to the inlet pipe;
attaching the standard showerhead to the two-way valve;
attaching the flexible conduit to the two-way valve; and
turning on the water supply to the inlet pipe.
